(19) United States
(12) Patent Application Publication
(10) Pub. No.: US 2005/0163667 A1
(43) Pub. Date: Jul. 28, 2005

(54) Single-use biobags with sendors: DO, pH, CO2 and temperature

(76) Inventor: Richard J. Krause, Perkasie, PA (US)

Correspondence Address: RICHARD J. KRAUSE, 16 SMITH SCHOOL ROAD, PERKASIE, PA, 18944, US

(21) Appl. No.: 11/040,702

(22) Filed: Jan. 24, 2005

Related U.S. Application Data
(60) Provisional application No. 60/539,092, filed on Jan. 26, 2004.

(51) Int. Cl. B01L 3/00

(52) U.S. Cl. 422/102; 422/56

(57) ABSTRACT

A single-use biobag provided with at least two none invasive florescent-optical sensors. The sterile sensors inside the biobag secured by an adhesive backing or secured by a CLASS VI fitting assures the sterile environment of the fluids in the bags. The sensors detectors are located outside the bag and secured in a position to align the sensors with the detectors. Either Velcro on the detector and outside of the bag has been used for sensor/detector alignment or the detector is mounted on the containment vessel and biobag straps are used to assure position of the bag for sensor/detector alignment. The process variables to be measured by the fluorescent optical disposable sensors are: DO, pH, CO₂ and temperature. The biobag film is CLASS VI material and should be optically clear and free of interfering florescent compounds.

### CROSS-REFERENCE TO RELATED APPLICATIONS

This invention uses single-use non-invasive fluorescent—optical patch sensors with single-use sterile or non-sterile biobags. The single-use sensors which can measure: DO, pH, CO₂ and temperature were patented by the University of Maryland and manufactured by Fluorometrix, Inc., Stow, Mass.

### STATEMENT REGARDING FEDERALLY SPONSORED RESEARCH OR DEVELOPEMENTS

No federal assistance used.

### BACKGROUND OF THE INVENTION

The single-use biobags with sensors will target the Pharmaceutical and Biotechnology industries but is not limited to these industries. The biobags are typically gamma sterilized and singleuse to assure the sterile storage or processing of fluids used in the bioprocess. However in some applications where the sterility is not an issue the sensors and bags can be reused. Sterile bags with bioprocess sensors are available today using conventional sensors. The conventional DO sensors may use a silicon membrane to isolate the sensor from the process fluids and other conventional sensors are reusable after sterilization. The advantage of the single-use bag with low cost single-use optical sensors is to improve the measurement of the process variables of the fluids in the bag, while elimination of cross contamination, improved the sterile environment, reduce clean-up and shorten validation time required with glass or stainless steel vessels. The major concern using biobags is the lack of a low cost method of measuring the process variables of the fluids in the biobags. When media is stored the temperature and pH can be important information to optimize the process. In the use of single-use biobags as bioreactor bags the parameters: DO, pH, CO₂ and temperature are critical to monitor and control the cell culture and fermentation processes.

The low cost single-use fluorescent-optical sensors will allow many bioprocesses applications to be processed in single-use bags rather than the traditional stainless steel vessels. The fluorescent-optical sensors used with a single-use biobags provides an opportunity to develop complete “single-use biobag suites”, complete disposable biobag processes for product discovery and manufacturing in the pharmaceutical industry. The non-invasive florescent patches have be used with glass bioreactor vessels and laboratory plastic or glass flasks. Our development is focused strictly on single-use biobag applications.

### BRIEF SUMMARY OF THE INVENTION

A biobag is made of class VI film having multiple (more than two) Non-invasive florescent-optical sensors installed on the inside film surface of the bags during manufacturing of the biobags. The florescent-optical sensors are low cost primarily for single-use sterile applications were the biobag is gamma irritated. The single-use bags can range in size from 30 ml to 10,000 liters. The bags can be round or square any dimension.

The non-invasive florescent-optical sensors will allow measurement of the process variables of liquid inside the bags: DO, pH, CO₂ and temperature.

### BREIF DESCRIPTION OF DRAWINGS

FIG. 1—(page 10 of 12) drawing of a mixing bag with optical sensor, detector, and biobag film orientation

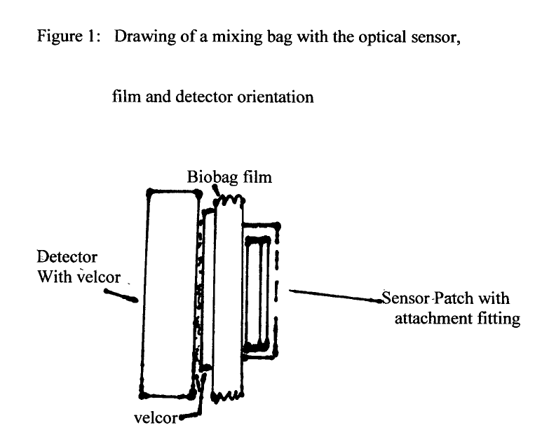

FIG. 2—(page 11 of 12) drawing of optical sensor patch with detector components

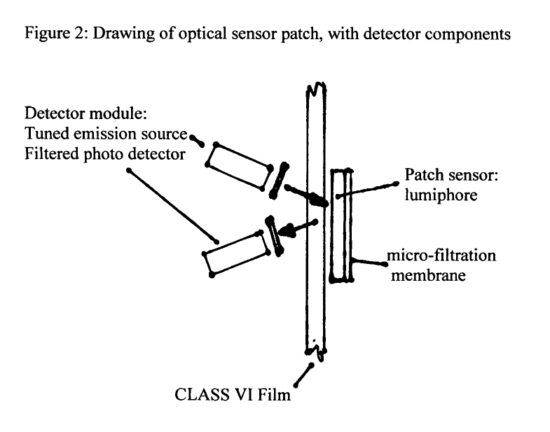

### DETAILED DESCRIPTION OF THE INVENTION

The invention of the single-use biobag with single-use optical sensors for measuring process variables in the liquid contained in the biobags. The non-invasive sensor measuring: DO, pH, CO₂ and temperature are attached to the inside of the optically clear biobag CLASS VI film during manufacturing. The biobags are typically gamma irradiated and bags are a closed system to assure a sterile container for liquids used in the Pharmaceutical and Biotechnology applications. The florescent optical patches are low cost ideal for single-use applications. The sensors are commercially available from Fluorometrix Inc. The sensors use fluorescence phased based measurement technology for the DO measurement which offers a robust, electronically stable sensor. The sensors are typically insensitive to noise and ambient light. The characteristics of fluorescent sensors are they are more accurate at low levels of measurement. The calibration of the sensor patches is simple and quick, requires a batch code to be entered only once, when changing sensor patch. Subsequent biobags with the same sensors will not require a recalibration. The sensor patches can be provided with strong adhesive for attaching to the inside of the bag film during manufacturing or a patch with no adhesive is secured to the inside of the bag film by a CLASS VI fitting which holds the patch against the film. The detectors with the excitation lamp filter and photo detectors are located on the outside of the biobags. They are secured in position to align the sensors and detectors. One method used to assure alignment is a color coded velcor strips for each process variable. Velcor is to attached to the outside of the bags and the detectors with the matching velcor colors to assure proper sensor detector type and alignment. The detector is a small module 3′ in diameter, which is connected by a cable to a signal conditioning box which is connects to a PC by a USB cable for signal and power. Future systems will have the signal conditioning box with optical readout monitor the process variables and external outputs for process closed loop control. Output options will be RS232, RS485, MODBUS, 0 to 20 ma and 4 to 20 ma. The sensors will allow a single-use disposable bag with sensors to replace conventional reusable sensor in the traditional stainless steel vessels. The biobag film used is optically clear and free of florescent components which can interfere with the sensor patch measurement. The biobag film we have selected has a small florescent component but it is reduced to an acceptable level by gamma irradiated the biobag. The optical sensors can be placed anywhere in the biobag under the liquid level, the size and shape or the bag can vary from round to square and 30 ml to 10,000+liters. Most Pharmaceutical and Biotech applications will be closed system and gamma sterilized. The biobags: film, tubes, connectors, filters, fittings, mixer impellers, and are aerator made with CLASS VI materials.

1. Single-use (sterile or non-sterile biobags) with more than one non-invasive fluorescent-optical patch sensor.

2. Non-Invasive sensor patches and detector attachment to the bag. Sensor patches are secured to the inside of the bag film with an adhesive backing on the sensor patch or with a fitting on the inside of the bag. The fluorescent-optical sensor patch inside the bag and detectors on the outside of the bag are aligned for the optimal transmission of the excitation source and sensor emission.

3. The florescent-optical patch sensors used in combination with the biobags will measure: dissolved oxygen, pH, CO₂ and temperature of the liquids contained within the biobags
